(19) United States
(12) Patent Application Publication
(10) Pub. No.: US 2008/0126107 A1
(43) Pub. Date: May 29, 2008

(54) METHOD AND SYSTEM FOR DETERMINING ONE OR MORE ROYALTY DISTRIBUTIONS

(76) Inventor: Walter Andres Callerio, Huntington Beach, CA (US)

Correspondence Address: PATENT INGENUITY, PC, 520 BROADWAY, SUITE 350, SANTA MONICA, CA, 90401, US

(21) Appl. No.: 11/534,598

(22) Filed: Sep. 22, 2006

(51) Int. Cl. G06Q 30/00

(52) U.S. Cl. 705/1

(57) ABSTRACT

A method determines one or more royalty distributions. The method determines a predetermined royalty rate for one or more sales of media content. Further, the method determines one or more predetermined royalty sharing percentages of the royalty rate. In addition, the method stores the media content on a media server. The method provides a web server with access, through a network, to the media content stored on the media server. The web server hosts a web page that offers the media content for sale. Further, the method calculates, in real time with processing of one or more sales orders received on the media server for the media content, one or more royalty distributions based on sales revenue and the one or more predetermined royalty sharing percentages. Finally, the method updates, in real time with the calculating of the one or more royalty distributions, one or more accounts. Each of the accounts is associated with a royalty distribution.

### BACKGROUND

1. Field

The disclosure generally relates to sales of media content. More particularly, the disclosure relates to the determination of royalties for the sales of the media content.

2. General Background

Media, such as songs and videos, are now commonly sold through venues such as the Internet. A purchaser can visit a web site and purchase an electronic version of the media, which can then be listened to or viewed by the purchaser. From the purchaser's standpoint, the process of obtaining media has been significantly expedited in comparison with the conventional method of traveling to a retail location for such a purchase.

However, the artist, producer, record label, and any other person or entity involved in making the media have not been privy to a significant increase in the efficiency for which royalties are collected for the media. With respect to retail sales, various intermediaries conventionally gather sales data from the retail locations. That sales information may then be forwarded to an intermediary that figures out what percentage of the royalties are to be distributed to the different persons or entities involved in making the media. In addition, the distribution information may be forwarded to yet another intermediary that actually distributes the royalties to the persons and entities involved in making the media.

Electronic sales of media over venues such as the Internet have not significantly expedited royalty distribution. Although the end user receives the media much faster than through a convention retail purchase, there is still a number of intermediaries involved in the process. As a result, there is normally a very large time delay for artists, producers, record labels, etc. to actually receive the royalty distributions. Further, there is very little transparency to allow an artist, producer, record label, etc. to verify the accuracy of the sales data.

### SUMMARY

In one aspect of the disclosure, a method determines one or more royalty distributions. The method determines a predetermined royalty rate for one or more sales of media content. Further, the method determines one or more predetermined royalty sharing percentages of the royalty rate. In addition, the method stores the media content on a media server. The method provides a web server with access, through a network, to the media content stored on the media server. The web server hosts a web page that offers the media content for sale. Further, the method calculates, in real time with processing of one or more sales orders received on the media server for the media content, one or more royalty distributions based on sales revenue and the one or more predetermined royalty sharing percentages. Finally, the method updates, in real time with the calculating of the one or more royalty distributions, one or more accounts. Each of the accounts is associated with a royalty distribution and is stored on the media server.

In another aspect of the disclosure, a method determines one or more royalty distributions. The method determines a predetermined royalty rate for one or more sales of media content. Further, the method determines one or more predetermined royalty sharing percentages of the royalty rate. In addition, the method stores the media content on a media server. The method also provides a web server with access, through a network, to the media content stored on the media server. The web server hosts a web page that offers the media content for sale. Further, the method receives sales information, from a third party media server at which the media content is also stored, for one or more sales of the media content at the third party web server. The third party web server hosts a web page that offers the media content for sale. In addition, the method calculates, in real time with processing of one or more sales orders received on the media server for the media content, one or more royalty distributions based on sales revenue and the one or more predetermined royalty sharing percentages. The method also calculates, in real time with reception of the sales information from the third party web server, one or more owed royalty distributions based on the sales information and the one or more predetermined royalty sharing percentages. Further, the method updates, in real time with the calculating of the one or more royalty distributions, one or more accounts stored on the media server, each of the accounts associated with a royalty distribution. Finally, the method displays, in real time with the calculating of the one or more owed royalty distributions, the one or more owed royalty distributions associated with each account.

In yet another aspect of the disclosure, a method determines one or more royalty distributions. The method determines a predetermined royalty rate for one or more sales of media content. Further, the method determines one or more predetermined royalty sharing percentages of the royalty rate. In addition, the method provides a web server with access, through a network, to a media server, the web server storing the media content. The web server hosts a web page that offers the media content for sale. Further, the method calculates, in real time with processing of one or more sales orders received on the media server for the media content, one or more royalty distributions based on sales revenue and the one or more predetermined royalty sharing percentages. Finally, the method updates, in real time with the calculating of the one or more royalty distributions, one or more accounts stored on the media server, each of the accounts associated with a royalty distribution.

### DRAWINGS

The above-mentioned features and objects of the present disclosure will become more apparent with reference to the following description taken in conjunction with the accompanying drawings wherein like reference numerals denote like elements and in which:

FIG. 1 illustrates a plurality of royalty sharing distribution percentages for a royalty rate from media content.

FIG. 2 illustrates a media server that can be utilized to perform a number of functions regarding royalty distribution.

FIG. 3 illustrates multiple pieces of media content, each having a different royalty sharing distribution.

FIG. 4 illustrates a process that can be utilized to determine one or more royalty distributions.

FIG. 5 illustrates the web server being a vendor web server that interacts with the media server.

FIG. 6 illustrates a process for determining one or more royalty distributions.

FIG. 7 illustrates the web server being an affiliate web server that interacts with the media server.

Further, FIG. 8 illustrates the vendor web server and a plurality of affiliate web servers interacting with the media server through the Internet.

FIG. 9 illustrates a third party web server that interacts with the media server through the Internet along with the media server and the plurality of affiliate web servers.

FIG. 10 illustrates a process that determines one or more royalty distributions.

### DETAILED DESCRIPTION

A method and system for distributing royalties is disclosed. Royalty distributions are determined in real time so that a person or entity involved in making media can determine the current amount of royalty distributions quickly and efficiently. Further, the royalty distributions are provided directly to the person or entity. Therefore, an artist, producer, record label, etc. can review sales information to ensure that the royalty distributions are accurate and quickly receive the royalty distributions.

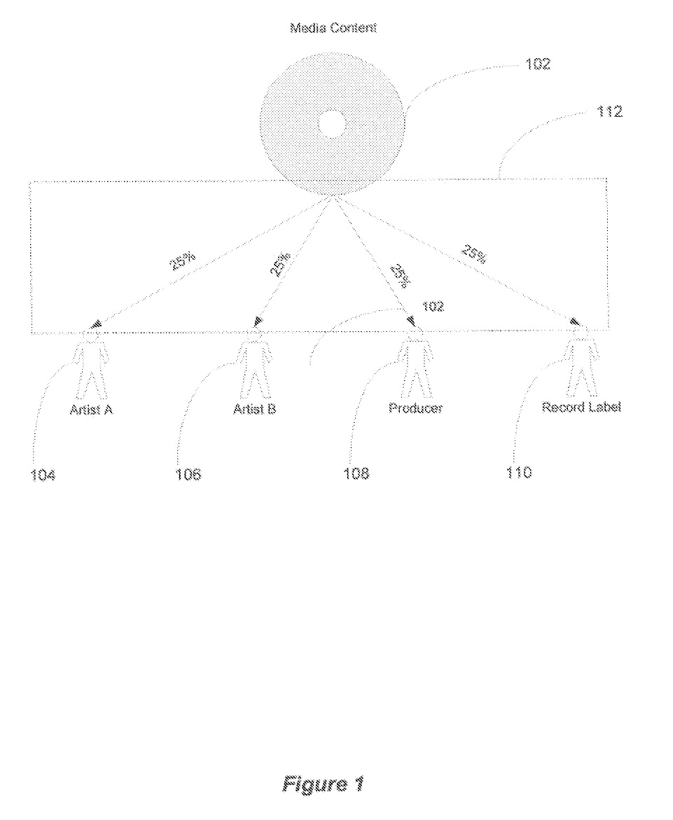

FIG. 1 illustrates a plurality of royalty sharing distribution percentages for a royalty rate from media content 102. The media content 102 can be an audio file, video file, streamed data, ring tone, graphic art, software, an e-book, or any other digital file known to one of ordinary skill in the art. For illustrative purposes, the media content 102 is illustrated as a CD. The media content 102 can be transferred from any computer readable medium, such as a floppy disk, CD, etc. to any electronic format known to one of ordinary skill in the art. Alternatively, the media content 102 may be recorded in an electronic format and may not need to be transferred from a computer readable medium.

A royalty rate can be established for each piece of media content 102. For instance, the persons and entities that are entitled to royalties for the media content 102 can come to an agreement with a distributor as to the percentage of revenues from sales of the media content 102 that will be the predetermined royalty rate. As an example, a royalty rate of five percent can be established as the predetermined royalty rate. Accordingly, if the sales revenue for the media content 102 equals one million dollars, the royalty is fifty thousand dollars.

Further, a predetermined royalty sharing distribution 112 can be determined. For example, the persons and entities involved in making the media content 102 may be an Artist A 104, an Artist B 106, a Producer 108, and a Record Label 110. A predetermined royalty distribution 112 may be established to give each an equal percentage of the royalty rate, i.e., twenty five percent each. In the example above, if the royalty rate is five percent, each would receive one and one quarter percent of the sales revenue from the sales of the media content 102. If the total sales revenue is one million dollars, each would receive twelve thousand five hundred dollars.

The royalty sharing distributions do not have to be established to provide for an equal distribution. The royalty sharing distribution as shown in FIG. 1 is not limited to twenty five percent, and is used only for exemplary purposes. The royalty sharing distribution may be divided among any number of persons or entities, and may be any amount. For instance, the record label may try to obtain a larger percentage than the other persons and entities.

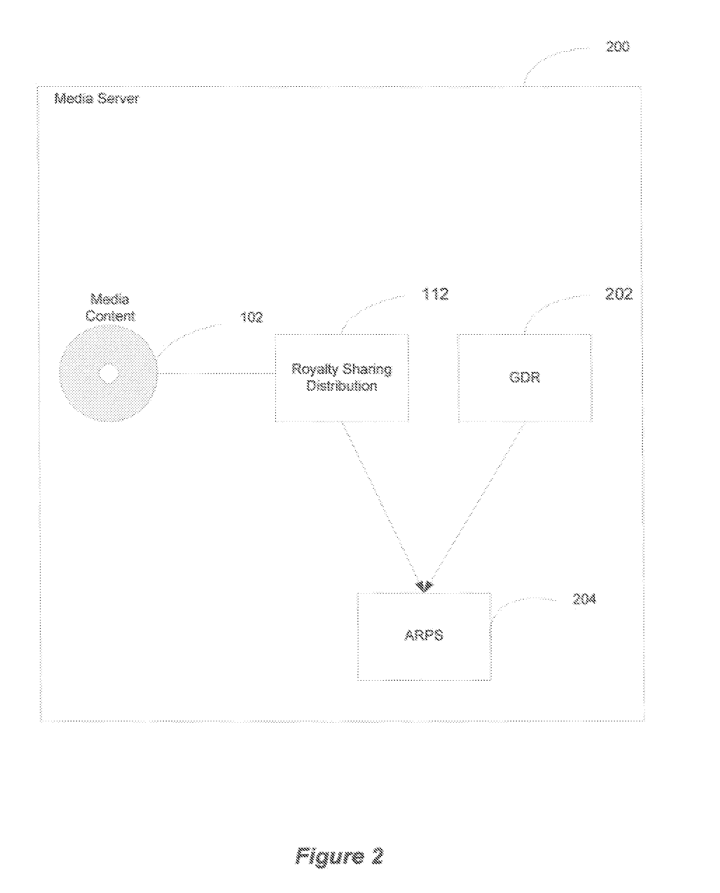

FIG. 2 illustrates a media server 200 that can be utilized to perform a number of functions regarding royalty distribution. In one embodiment, the media content 102 is stored on the media server 200. In another embodiment, the media content 102 is stored on a computer readable medium that is associated with the media server 200, i.e., operably connected to the media server 200 or remotely accessible by the media server 200. In yet another embodiment, the media content 102 is stored on a server other than media server 200, or a computer readable medium associated with the server, that offers the media content 102 for sale and communicates with the media server 200. Finally, some media content 102 may be stored according to one configuration while other media content 102 may be stored according to another configuration. For instance, a first digital music file may be offered for sale by a server and stored on the media server 200 while a second digital music file may be offered for sale by a server and stored on the server. Data would be sent to the media server 200 to request the first digital music file in addition other possible information regarding the sale where as sales information without the download request would be sent to the media server 200 for the second digital music file.

In one embodiment, the media server 200 can also perform the functions of a web server and host a web page. For instance, the media server 200 may host a web page on which users can access accounts to view royalty distributions. Alternatively, the media server 200 may work in conjunction with a web server to perform these functions.

For illustrative purposes, FIG. 1 illustrates the media content 102 being stored on the media server 200. Further, FIG. 1 illustrates one piece of media content 102 being stored on the media server 200 for illustrative purposes, but a plurality of pieces of media content 102 can be stored on the media server 200. Each of the pieces of media content 102 has a corresponding royalty sharing distribution 112. For example, one piece of media content 102 may have a royalty sharing distribution 112 in which the Artist A 104, the Artist B 106, the Producer 108, and the Record Label 110 each receive a twenty five percent share of the royalty rate while another piece of media content 102 may have a royalty sharing distribution 112 in which the Artist A 104 and the Artist B 106 each receive ten percent of the royalty rate, and the Producer 108 and the Record Label 110 each receive forty percent of the royalty rate.

The royalty sharing distribution 112 can be stored on the media server 200 or on a computer readable medium associated with the media server 200. If the media content 102 is stored on a distinct server that offers the media content 102 for sale, the royalty sharing distribution 112 can still be stored on the media server 200. A correspondence between the media content 102 and the royalty sharing distribution 112 can be established so that sales information received from the server can be divided according to the royalty sharing distribution 112 by the media server 200.

Data associated with each of the pieces of media content 102 can be stored in a Global Data Repository (“GDR”). For instance, the sales revenue figures for each piece of media content 102 can be stored in the GDR 202. In one embodiment, the GDR 202 stores the sales transaction data and sales revenue data for the pieces of media content 102 that are stored on the media server 200 where as the GDR 202 may store sales revenue data for the pieces of media content 102 that are stored on another server that offers the pieces of media content 102 for sale. In another embodiment, even if the pieces of media content 102 are stored on another server that offers the media content 102 for sale, the execution of the sales transaction may actually take place through the media server 200. In this instance, the GDR 202 would store the sales transaction data and sales revenue data for the pieces of media content 102 offered for sale on the other server. For illustrative purposes, the GDR 202 in FIG. 2 is illustrated as having data for one piece of media content 102, but the GDR 202 can have data for a plurality of pieces of media content 102, with the data being received according to different configurations, some of which are discussed above.

For each piece of media content 102, an Automated Royalty Payment System (“ARPS”) 204 receives data from the GDR 202 and applies the royalty sharing distribution 112 to the data in real time. In other words on a product-by-product basis, the ARPS 204 receives data regarding the sale of each product from the GDR 202. For example, a digital music file may be stored and sold off a server other than the media server 200, but the execution of the sale may take place on the media server 200. In this instance, data regarding the revenue of the sale is provided from the GDR 202 to the ARPS 204 for an immediate determination of the royalty distribution to each person or entity entitled to royalty sharing. Further, other copies of the digital music file may be simultaneously sold according to the various configurations discussed above. The GDR 202 would then provided sales revenue data for a number of copies of the digital music file so that the ARPS 204 can calculate royalty distributions for each person or entity entitled to royalty sharing.

The ARPS 204 can be a software module that is stored on the media server 200 or on a storage medium operably connected to or remotely associated with the media server 200. Alternatively, the ARPS 204 can be a piece of hardware that is configured to work in conjunction with the media server 200. Further, the data for each account may be stored on the media server 200 on a storage medium operably connected to or remotely associated with the media server 200.

In one embodiment, an account is established for each potential recipient of a royalty distribution. As the ARPS 204 calculates the royalty distributions, the ARPS 204 updates each of the accounts in real time. For example, an account may be set up for each of the Artist A 104, the Artist B 106, the Producer 108, and the Record Label 110. As the piece of media content 102 illustrated in FIG. 1 is sold, even from various difference sources according to the configurations described above, the account of each of the Artist A 104, the Artist B 106, the Producer 108, and the Record Label 110 is updated in real time to reflect the equal twenty five percent share of the five percent royalty rate. In other words, as a product is sold, the account holder automatically receives a credit into his or her account for the share of the royalty distribution he or she is entitled to. Further, the ARPS 204 updates the account in real time as more copies of the product are sold so that the account holder can see an immediate reflection of the royalty distribution he or she is entitled to. In addition, the account holder can verify that he or she is receiving the correct royalty distribution as he or she can monitor each sale and the application of the royalty sharing distribution 112 to each sale. This is in contrast to a lack of transparency and waiting a long period of time for various intermediaries to gather and tally sales data to eventually provide a recipient with a royalty distribution.

In another embodiment, the expenses for an account holder can be deducted in real time along with the gather of royalty distributions. For instance, an account holder may choose to purchase a piece of media content 102 that is stored on the media server 200, but for which he or she is not entitled to a royalty distribution. The cost of purchasing the piece of media content 102 is deducted in real time from the total amount in the account that has been updated from the royalty distributions that have been received while a royalty distribution is added to the account holder entitled to a royalty distribution. The expenses can include a vast array of other items, including but not limited to the cost of utilizing the ARPS service. Accordingly, an account holder is able to place his or her royalty distributions towards expenses as opposed to incurring expenses and having to wait a long period of time for a royalty distribution.

In one embodiment, an accounting software module can be provided in conjunction with the ARPS 204 to keep track of and make calculations for the royalty distributions and expenses. The accounting software module can be stored on the media server 200 or on a storage medium operably connected to or remotely associated with the media server 200. Alternatively, the ARPS 204 can have built-in accounting capabilities so that an accounting software module is not needed.

In another embodiment, a business analysis reporting module can be provided in conjunction with the ARPS 204. The business analysis reporting module can be generated reports for the account holder. These reports may include a variety of analyses, such as statistics regarding sales revenue and royalty distributions.

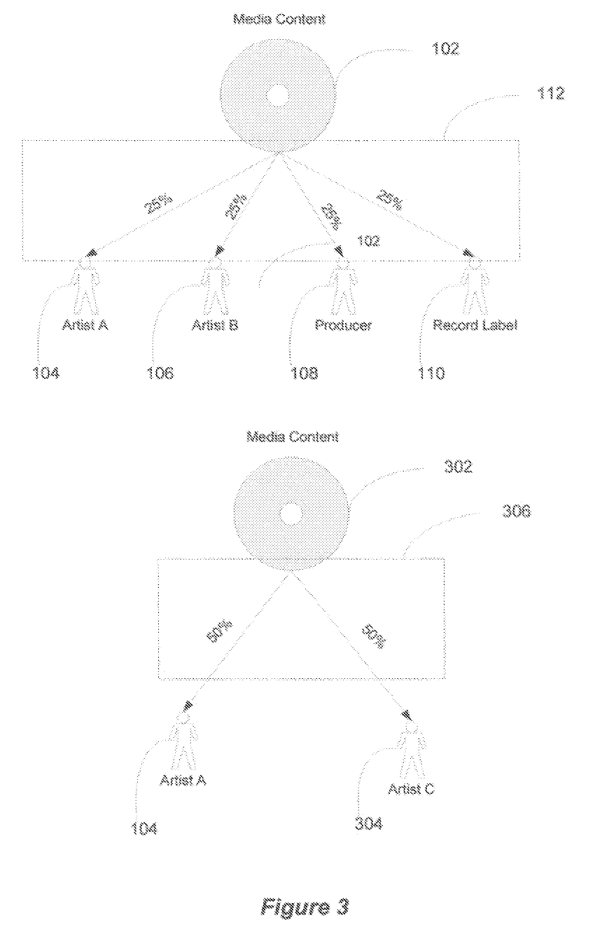

FIG. 3 illustrates multiple pieces of media content, each having a different royalty sharing distribution. For example, the Artist A 104 may be involved in the creation of multiple digital music files. As illustrated in FIG. 1, the Artist A 104 worked with the Artist B 106, the Producer 108, and the Record Label 110 on the media content 102. However, Artist A 104 may have also created another piece of media, media content 302, in collaboration with Artist C, but without the involvement of a producer or record label. Accordingly, a different royalty sharing distribution and possibly a different royalty rate may be established for the different media content 302. For example, a royalty sharing distribution 306 may be established so that the Artist A 104 receives fifty percent and the Artist C 304 receives fifty percent of a royalty rate of ten percent for the media content 302.

In one embodiment, the account for each account holder can be updated in real time for different pieces of media content having different royalty sharing distributions. For example, the Artist A 102 is entitled to twenty five percent of the five percent royalty rate for the sale of copies of media content 102 and fifty percent of the ten percent royalty rate earned for sale of copies of the media content 302. The ARPS 204 calculates the royalty sharing distributions for each of the pieces of media content 204 and updates the account of an account holder in real time to reflect the aggregate royalty distributions for multiple pieces of media content 102 for which an account holder is entitled to a royalty distribution. Accordingly, the ARPS 204 provides a centralized system for which an account holder can see an up to date snapshot of total royalty distributions, even for multiple pieces of media content.

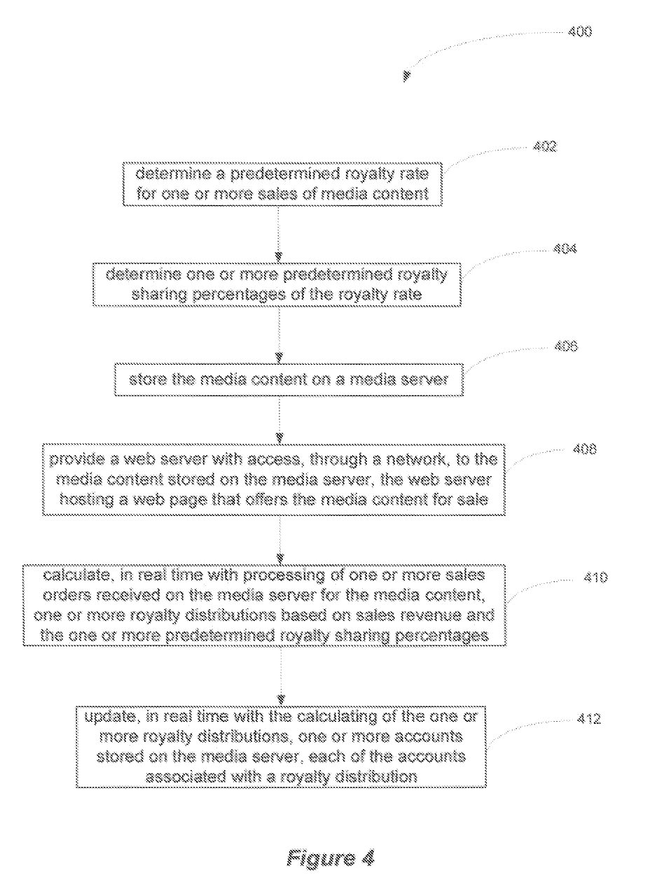

FIG. 4 illustrates a process 400 that can be utilized to determine royalties. At a process block 402, the process 400 determines a predetermined royalty rate for one or more sales of media content. Further, at a process block 404, the process 400 determines one or more predetermined royalty sharing percentages of the royalty rate. In addition, at a process block 406, process 400 stores the media content on a media server. At a process block 408, the process 400 provides a web server with access, through a network, to the media content stored on the media server. The network can be the Internet, a local area network (“LAN”), public switch telephone network (“PSTN”), or any other network known to one of ordinary skill in the art. The web server hosts a web page that offers the media content for sale. As discussed above, there are various configurations in which a server can offer media content for sale and work in conjunction with the media server 200, i.e., the logistics for sale transaction execution, media content storage, etc. Further, at a process block 408, the process 400 calculates, in real time with processing of one or more sales orders received on the media server for the media content, one or more royalty distributions based on sales revenue and the one or more predetermined royalty sharing percentages. The processing of the one or more sales orders varies amongst different configurations. For example, the media server 200 may execute sales transactions, which would constitute a processing of one or more sales orders. Further, the web server may execute a sales transaction for media content stored on the media server 200 and provide the sales information to the media server 200. The reception and organization of the sales information for inclusion in the GDR 202 by the media server 200 would also constitute a process of the sales information. Finally, at a process block 410, the process 400 updates, in real time with the calculating of the one or more royalty distributions, one or more accounts. Each of the accounts is associated with a royalty distribution.

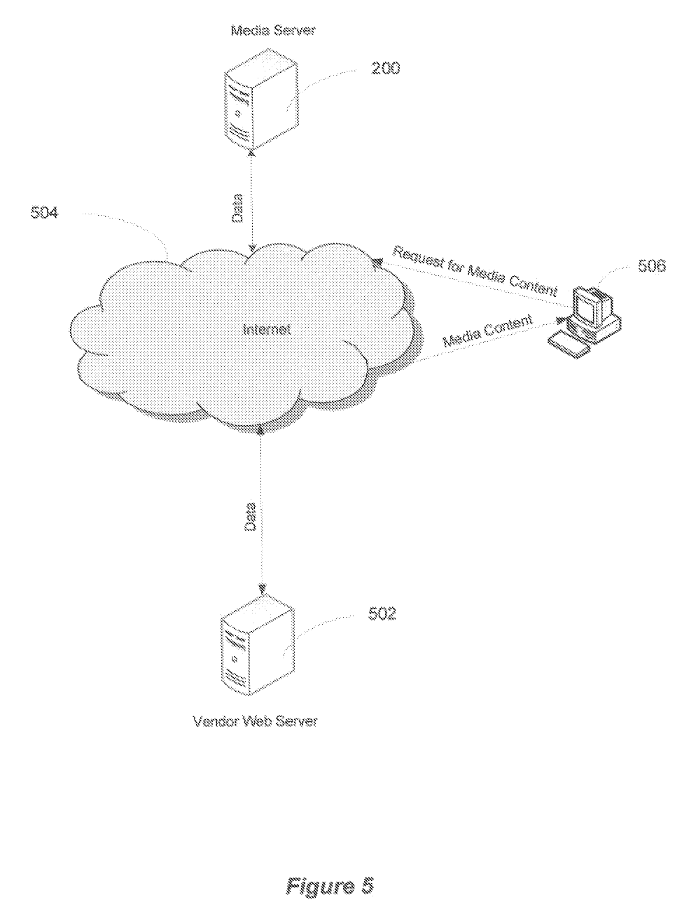

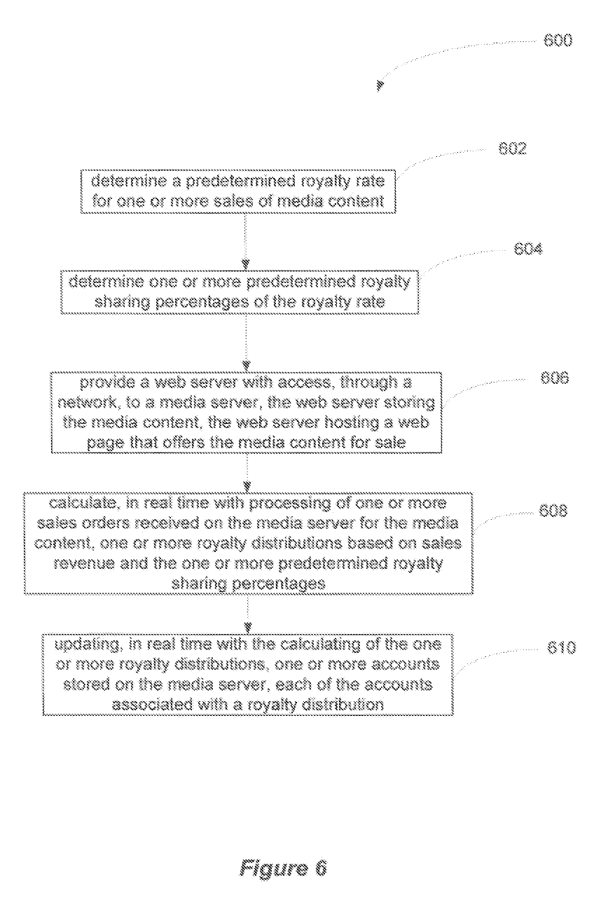

FIG. 5 illustrates the web server being a vendor web server 502 that interacts with the media server 200. The vendor web server 502 is a web server that is operated by an entity or person involved in a piece of media content 102. For instance, the vendor web server 502 can be hosted by an artist, producer, and/or record label. As opposed to relying on third party web sites to sell media content 102, the person or entity actively involved in working on the piece of media content 102 can sell the media content 102 directly from a web site. For instance, a band may have its own web site and may wish to sell its songs directly from its web site.

For illustrative purposes, FIG. 5 illustrates the vendor web server 502 interacting with the media server 200 through the Internet 504. However, the vendor web server 502 can interact with the media server 200 through any network recognized by one of ordinary skill in the art.

A user at a computing device 506 may access the web site hosted by the vendor web server 502 to request a purchase of the piece of media content 102. The computing device 506 can be any device that has a processor and is capable of accessing the Internet 504, e.g., personal computer, laptop, personal digital assistant (“PDA”), cellular phone, etc. In one embodiment, the vendor web server 502 stores the media content 102 but sends the information for the execution of the purchase to media server 200. Accordingly, the media server 200 processes the payment and can provide data back to vendor web server 502 indicating that the vendor web server can proceed with downloading a copy of the media content 102 to the user at the computing device 506. In real time, the ARPS 204 at the media server 200 can calculate the royalty distribution and update the account of the vendor.

In another embodiment, the vendor web server 502 offers the media content 102 for sale while the media server 200 stores the media content 102 and processes the payment. In this instance, the media server 200 performs the additional task of downloading the media content 102 to the vendor web server 502 so that the vendor web server 502 can download the media content 102 to the computing device 506.

In yet another embodiment, the vendor web server 502 stores the media content 102 and processes the payment for the media content 102. In this instance, the vendor web server 502 may wish to send the funds to the media server 200 so that these funds and the funds from sales at other servers for the media content 102 are aggregated at a centralized location. Alternatively, the vendor web server 502 may keep the funds and provide the sales data to the media server 200 for record keeping services. For instance, the royalty rate and/or royalty sharing percentages may be predetermined to change after certain milestones are reached. As an example, a royalty rate can be established as five percent for the first ten thousand sales and six percent for any sales above ten thousand sales. Accordingly, the vendor would likely want the sales at his or her web site to be included in the tally of sales by the media server 502.

In one embodiment, the media server 200 provides the vendor web server 502 with a software module. As an example, the software module can be a plug-in. The web sites of different artists, producers, record labels may vary quite a bit, and these persons or entities will likely want to change their web sites a little as possible to accommodate e-commerce. Accordingly, the software module can be a standardized piece of software that can be downloaded through the Internet 504 and easily integrated within an existing web site hosted by the vendor web server 502. In essence, the artist, producer, record label, etc. can continue operating a web site in the normal manner with the addition of a virtual storefront that is adapted to work on the web site. The virtual storefront allows the vendor web server to offer for sale a plurality of pieces of media content. Further, the software module can provide communication between the vendor web server 502 and the media server 200.

FIG. 6 illustrates a process 600 for determining a royalty distribution. At a process block 602, the process 600 determines a predetermined royalty rate for one or more sales of media content. Further, at a process block 604, the process 600 determines one or more predetermined royalty sharing percentages of the royalty rate. In addition, at a process block 606, the process 600 provides a web server with access, through a network, to a media server. The web server stores the media content. Further, the web server hosts a web page that offers the media content for sale. In one embodiment, the web server is the vendor web server. At a process block 608, the web server calculates, in real time with processing of one or more sales orders received on the media server for the media content, one or more royalty distributions based on sales revenue and the one or more predetermined royalty sharing percentages. Finally, at a process block 610, the process 600 updates, in real time with the calculating of the one or more royalty distributions, one or more accounts, each of the accounts associated with a royalty distribution.

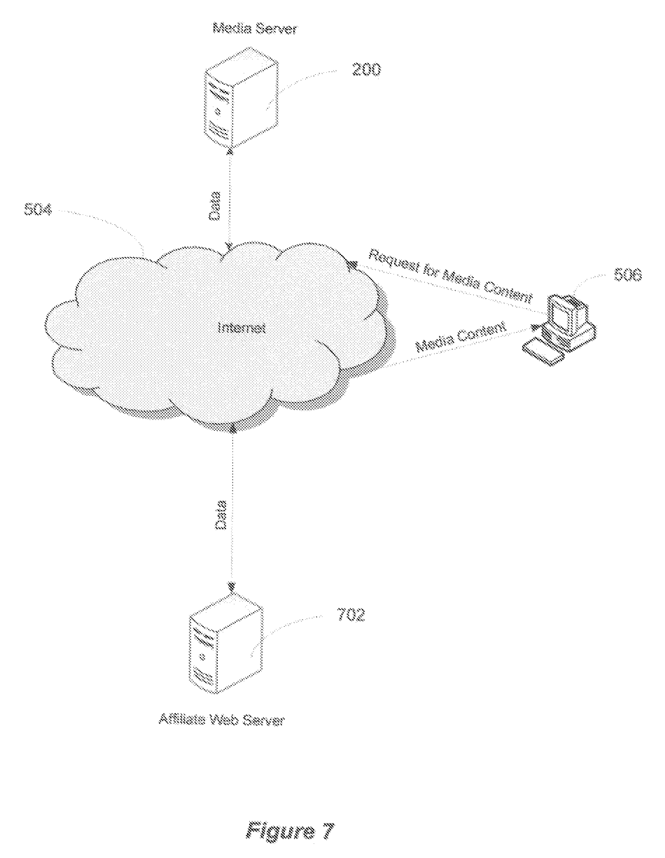

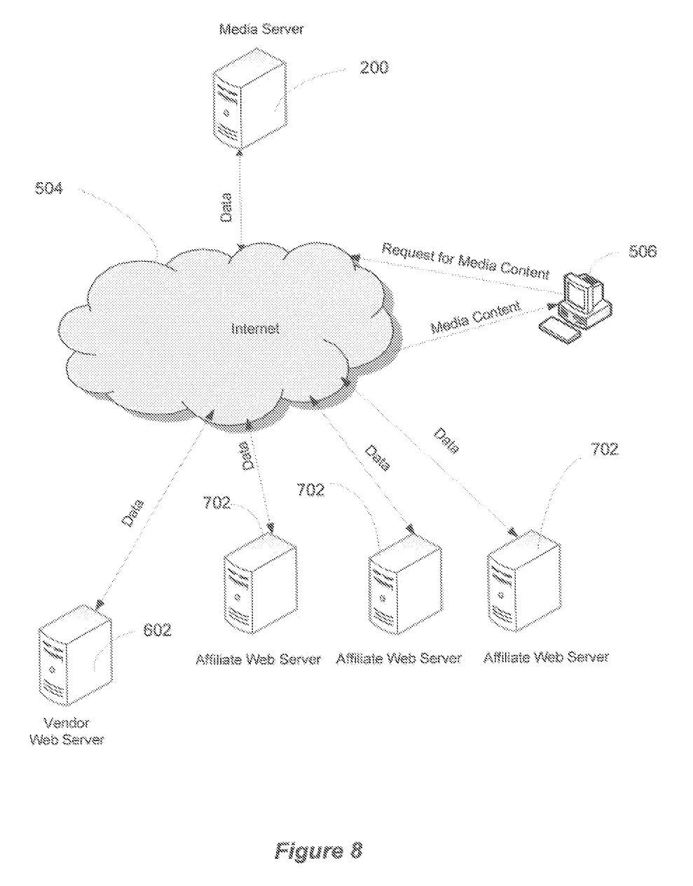

FIG. 7 illustrates the web server being an affiliate web server 702 that interacts with the media server 200. The affiliate web server 702 is a web server that is operated by an entity or person that is not involved in working on the piece of media content 102 for which the vendor is involved. In other words, an affiliate is a person or an entity that is not entitled to a royalty distribution for the sale of the media content 102. For instance, a rock n' roll song that is written by a rock 'n roll artist A may be offered for sale by an affiliate rock 'n roll artist B that was not at all involved in working on the rock 'n roll song. Rock 'n roll artist A may benefit because the web site of rock 'n roll artist B may attract some rock 'n roll fans that do not visit a third party web site that sells all kinds of music or even the web site of rock 'n roll artist A which may be focused on a different genre of rock 'n roll. In one embodiment, the affiliate is a vendor for a different piece of media content. Accordingly, artist B may also have written a rock 'n roll song that he or she sells on a web site as a vendor and for which artist A could potentially be an affiliate. As a result, there is an opportunity to cross-sell and allow artists to benefit from one another.

In one embodiment, the media server 200 stores the media content 102. The vendor can indicate whether the vendor would like to allow the media server 200 to provide the media content 102 for sale to one or more affiliate web servers 702.

In one embodiment, the media server 200 provides the affiliate web server 702 with a software module. The affiliate web server 702 can utilize the software module to communicate with the media server 200. For instance, the software module can receive information from the media server 200 that indicates which pieces of media content stored on the media server 200 are available for the affiliate web server 602 to offer for sale on the web site hosted by the affiliate web server 702. The software module can gather sales information on a product-by-product sale to transmit to the media server 200 on a real time basis so that the ARPS 204 at the media server 200 can calculate a royalty distribution to the one or more vendors of the piece of media content 102 and update user accounts accordingly.

Further, FIG. 8 illustrates the vendor web server 502 and a plurality of affiliate web servers interacting with the media server 200 through the Internet 504. While a vendor may benefit from selling the media content 102 directly through its web site, the vendor may also benefit by allowing a plurality of affiliate web servers to sell the media content 102. In one embodiment, the vendor may choose to offer for sale one piece of media content on its web site alone while allowing another piece of media content to be offered for sale on its web site and the affiliate web sites. The vendor may even choose to not sell a piece of media content on its web site, but to allow affiliate web sites to sell that piece of media content. For instance, an affiliate may have more interest in selling an outdated music song than the vendor who is attempting to reach a trendy audience.

In another embodiment, a vendor can indicate a preference for allowing certain affiliates to sell its media content as opposed to others. For instance, a preference for a category can be given. The vendor may only wish to allow the media server 200 to make a rock 'n roll song available to an affiliate who hosts a web site that can be categorized as a rock 'n roll web site as opposed to an affiliate that hosts a web site that can be categorized as a jazz web site. As a result, the vendor can target its audience and focus on developing a fan base for its media content.

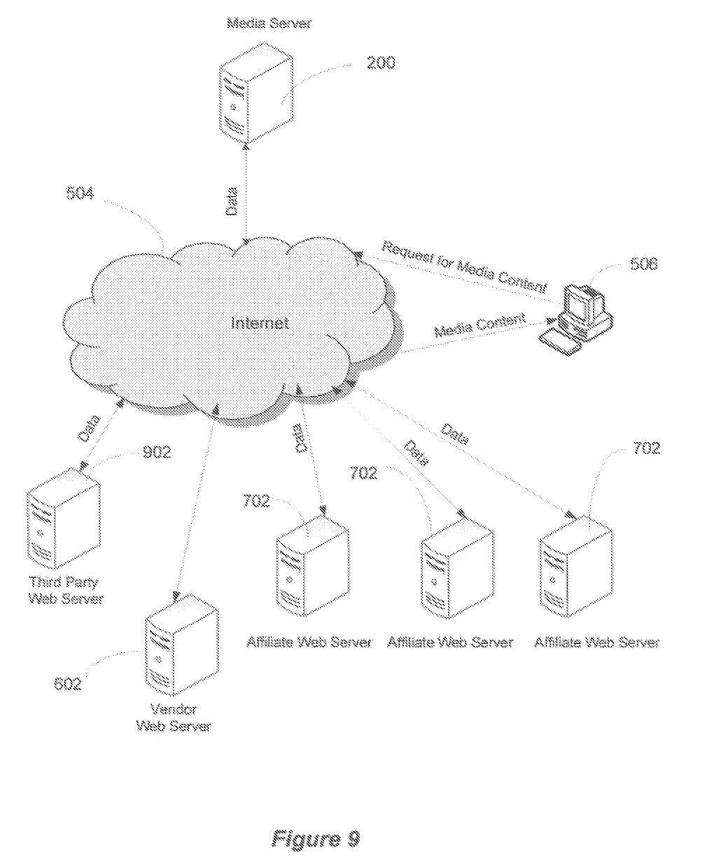

FIG. 9 illustrates a third party web server 902 that interacts with the media server 200 through the Internet 504 along with the media server 200 and the plurality of affiliate web servers 702. A third party web server is a web server that is operated by a person or entity that is not involved in working on a piece of media content 102 and is not an affiliate web server 702. For instance, the third party web server can be a web site that sells a large variety of digital media files. The third party web server may even sell a vast array of other types of products. Accordingly, the third party web server 902 can have an infrastructure to handle the storage of the media content 102 and the payment processing of a purchase by a user at a computing device 506. However, the sales information for each of the copies of the media content 102 can still be provided to the media server 200 so that the media server 200 provides an account holder with a real time indication of the total royalty distributions that are owed to the account holder. In one embodiment, the media server 200 updates the account of the account holder to reflect the actual royalty distributions credited to the account of the account holder, i.e. transactions from the vendor web server 602 and/or one or more of the plurality of affiliate web servers 702, and provides and indication of the remaining amount that the account holder is owed from the third party web server. Accordingly, the account holder is provided with transparency for all of the royalty distributions for online sales of copies of the media content 102.

The media server 200 can ultimately receive sales information from a variety of different sources. For example, for one piece of media content, the media server 200 may be configured to receive sales information for the vendor web server 602 and the plurality of affiliate web servers 702 while for another piece of media content, the media server 200 may be configured to receive sales information from the vendor web server 602 and the third party web server 902. Accordingly, a combination or sub-combination of the sources of sales information discussed above can be utilized to provide the media server 200 with sales information and/or other data associated with the media content 102.

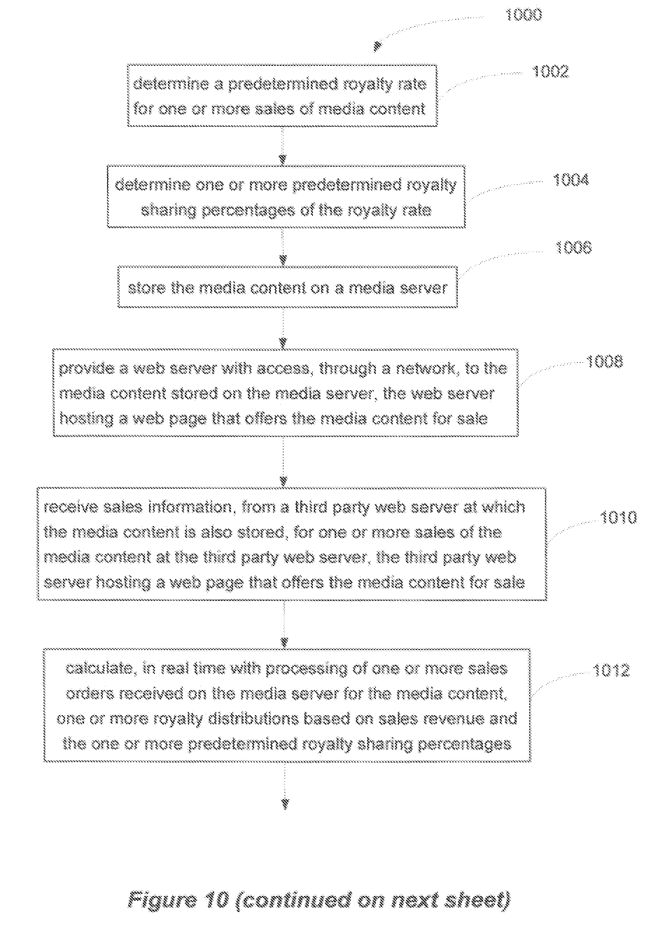

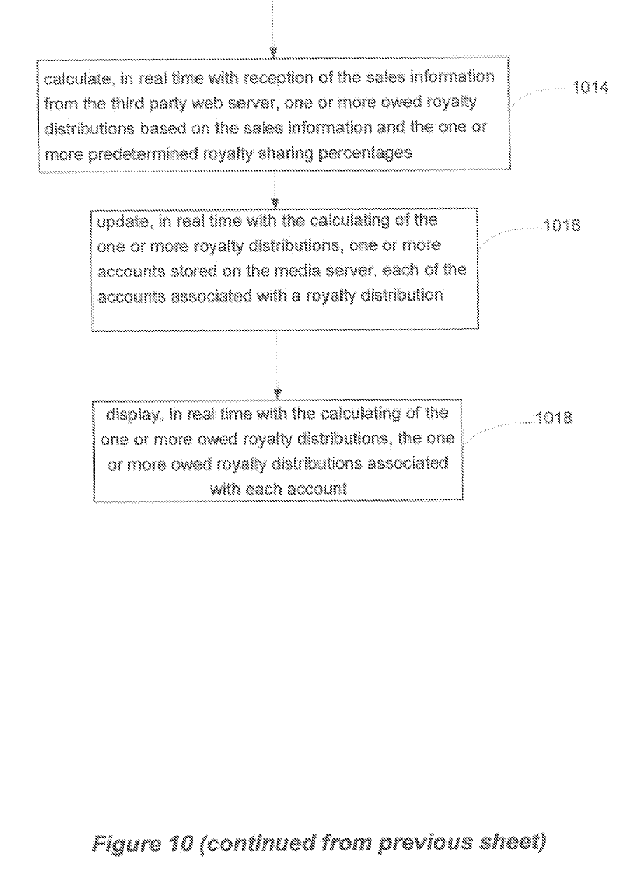

FIG. 10 illustrates a process 1000 that determines royalties. At a process block 1002, the process 1000 determines a predetermined royalty rate for one or more sales of media content. Further, at a process block 1004, the process 1000 determines one or more predetermined royalty sharing percentages of the royalty rate. In addition, at a process block 1006, the process 1000 stores the media content on a media server. At a process block 1008, the process 1000 provides a web server with access, through a network, to the media content stored on the media server, the web server hosting a web page that offers the media content for sale. For example, the web server can be the vendor web server 502 or the affiliate web server 702 discussed above. Further, at a process block 1010, the process receives sales information, from a third party web server which the media content is also stored, for one or more sales of the media content at the third party web server, the third party web server hosting a web page that offers the media content for sale. In addition, at a process block 1012, the process 100 calculates, in real time with processing of one or more sales orders received on the media server for the media content, one or more royalty distributions based on sales revenue and the one or more predetermined royalty sharing percentages. At a process block 1014, the process 1000 calculates, in real time with reception of the sales information from the third party web server, one or more owed royalty distributions based on the sales information and the one or more predetermined royalty sharing percentages. Further, at a process block 1016, the process 1000 updates, in real time with the calculating of the one or more royalty distributions, one or more accounts, each of the accounts associated with a royalty distribution. Finally, at a process block 1018, the process 1000 displays, in real time with the calculating of the one or more owed royalty distributions, the one or more owed royalty distributions associated with each account.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of determining one or more royalty distributions, the method comprising:
determining a predetermined royalty rate for one or more sales of media content;
determining one or more predetermined royalty sharing percentages of the royalty rate;
storing the media content on a media server,
providing a web server with access, through a network, to the media content stored on the media server, the web server hosting a web page that offers the media content for sale;
calculating, in real time with processing of one or more sales orders received on the media server for the media content, one or more royalty distributions based on sales revenue and the one or more predetermined royalty sharing percentages; and
updating, in real time with the calculating of the one or more royalty distributions, one or more accounts stored on the media server, each of the accounts associated with a royalty distribution.

2. The method of claim 1, wherein the web server is a vendor web server and the media content is created, produced, or manufactured by a vendor associated with the vendor web server.

3. The method of claim 2, wherein the processing of the one or more sales orders is a reception of sales data associated with an execution of a financial transaction between a purchaser of the media content and the vendor web server.

4. The method of claim 1, wherein the web server is an affiliate web server and the media content is created produced, or manufactured by a vendor other than an affiliate associated with the affiliate web server.

5. The method of claim 4, wherein the processing of the one or more sales orders is an execution of a financial transaction between a purchaser of the media content and the affiliate web server.

6. The method of claim 1, further comprising providing a software module to the web server to sell the media content.

7. The method of 6, wherein the software module transmits sales information associated with the media content to the media server.

8. The method of claim 1, wherein the media content is an audio file.

9. The method of claim 1, wherein the media content is a video file.

10. The method of claim 1, wherein one of the royalty sharing percentages is allocated for an owner of the media content.

11. The method of claim 1, wherein one of the royalty sharing percentages is allocated for an author of the media content.

12. The method of claim 1, wherein one of the royalty sharing percentages is allocated for a producer of the media content.

13. The method of claim 1, further comprising deducting one or more expenses from the royalty distribution.

14. The method of claim 13, wherein the one or more expenses include a purchase of distinct media content from one of the plurality of affiliate web servers.

15. The method of claim 13, wherein the one or more expense include a purchase of distinct media content from a web server other than the web server or the plurality affiliate web servers.

16. A method of determining one or more royalty distributions, the method comprising:
determining a predetermined royalty rate for one or more sales of media content;
determining one or more predetermined royalty sharing percentages of the royalty rate;
storing the media content on a media server,
providing a web server with access, through a network, to the media content stored on the media server, the web server hosting a web page that offers the media content for sale;
receiving sales information, from a third party media server at which the media content is also stored, for one or more sales of the media content at the third party web server, the third party web server hosting a web page that offers the media content for sale;
calculating, in real time with processing of one or more sales orders received on the media server for the media content, one or more royalty distributions based on sales revenue and the one or more predetermined royalty sharing percentages;
calculating, in real time with reception of the sales information from the third party web server, one or more owed royalty distributions based on the sales information and the one or more predetermined royalty sharing percentages;
updating, in real time with the calculating of the one or more royalty distributions, one or more accounts stored on the media server, each of the accounts associated with a royalty distribution; and
displaying, in real time with the calculating of the one or more owed royalty distributions, the one or more owed royalty distributions associated with each account.

17. The method of claim 16, wherein the media content is an audio file.

18. The method of claim 16, wherein the media content is a video file.

19. A method of determining one or more royalty distributions, the method comprising:
determining a predetermined royalty rate for one or more sales of media content;
determining one or more predetermined royalty sharing percentages of the royalty rate;
providing a web server with access, through a network, to a media server, the web server storing the media content, the web server hosting a web page that offers the media content for sale;
calculating, in real time with processing of one or more sales orders received on the media server for the media content, one or more royalty distributions based on sales revenue and the one or more predetermined royalty sharing percentages; and
updating, in real time with the calculating of the one or more royalty distributions, one or more accounts stored on the media server, each of the accounts associated with a royalty distribution.

20. The method of claim 19, further comprising providing a software module to the web server to sell the media content and to transmit sales information associated with the media content to the media server.
